(19) United States
(12) Patent Application Publication
(10) Pub. No.: US 2021/0298231 A1
(43) Pub. Date: Sep. 30, 2021

(54) AUTONOMOUS WORK MACHINE, AUTONOMOUS WORK SETTING METHOD, AND STORAGE MEDIUM

(71) Applicant: HONDA MOTOR CO., LTD., Tokyo (JP)

(72) Inventors: Taro Yokoyama, Wako-shi (JP); Hiroto Takahashi, Wako-shi (JP); Toshiaki Kawakami, Wako-shi (JP); Wei Song, Wako-shi (JP); Takuya Kanisawa, Wako-shi (JP)

(21) Appl. No.: 17/211,876

(22) Filed: Mar. 25, 2021

(30) Foreign Application Priority Data
Mar. 27, 2020 (JP) 2020-057498

(51) Int. Cl. A01D 34/00; G06K 9/00; G08B 7/06

(52) U.S. Cl. CPC A01D 34/008; G06K 9/00805; A01D 2101/00; G06K 9/00335; G08B 7/06; G06K 9/00362

(57) ABSTRACT

An autonomous work machine includes a detection unit configured to detect a person present in an advancing direction of an own apparatus, a notification unit configured to perform a first notification on the detected person, a reaction detection unit configured to detect a reaction of the person when the first notification is performed, and a control unit configured to determine whether or not a notification from the notification unit is continued on the basis of the detected reaction, and select a second notification different from the first notification on the basis of the detected reaction and cause the notification unit to perform the second notification in a case where it is determined that the notification is continued.

### CROSS-REFERENCE TO RELATED APPLICATION

Priority is claimed on Japanese Patent Application No. 2020-057498, filed Mar. 27, 2020, the content of which is incorporated herein by reference.

### BACKGROUND OF THE INVENTION

### Field of the Invention

The present invention relates to an autonomous work machine, an autonomous work setting method, and a storage medium.

### Description of Related Art

A system that provides guidance to customers in a store or a factory has been proposed. In this system, for example, a store is provided with a communication robot and a counter reception machine. In a case where a customer is a healthy person, the communication robot asks the customer to state a request, acquires the statement, and acquires the request through voice recognition. The communication robot issues a reception number in response to the request, guides the customer with the reception number to a counter, and the like. In a case where a captured image includes a customer and a guide dog, the communication robot determines that the customer is a visually impaired person. A counter reception machine asks the customer to wait (for example, refer to Japanese Unexamined Patent Application, First Publication No. 2017-222021 (hereinafter, Patent Document 1)).

A system has been proposed in which a robot guides a visually impaired person in order to avoid a collision between the visually impaired person and another user. The system acquires the current position of the robot, and positions, advancing directions, and advancing speeds of the visually impaired person and another user from sensors. The system generates a route of the visually impaired person and a route of the robot, and creates a safety map for predicting collision with at least one of the visually impaired person and the robot. The system determines which one of the visually impaired person and the robot is in danger of collision, and changes the route of the visually impaired person or the route of the robot according to the danger of collision (for example, refer to Japanese Unexamined Patent Application, First Publication No. 2016-62587 (hereinafter, Patent Document 2)).

### SUMMARY OF THE INVENTION

In the techniques disclosed in Patent Documents 1 and 2, a visually impaired person is set in advance as a target, and a behavior corresponding to the visually impaired person is selected. However, in a case where a status or an attribute of a person, such as a target person being a healthy person, a visually impaired person, or a hearing impaired person, cannot be known, it is not possible to cope with a case where there is no reaction even if a specific means is used.

Aspects related to the present invention have been made in light of the problems, and an object thereof is to provide an autonomous work machine, an autonomous work setting method, and a storage medium capable of performing communication with a target person even in a case where a status or an attribute of the target person cannot be understood.

In order to solve the problems and to achieve the object, the present invention employs the following aspects.

(1) According to an aspect of the present invention, there is provided an autonomous work machine including a detection unit configured to detect a person present in an advancing direction of an own apparatus; a notification unit configured to provide a first notification to the detected person; a reaction detection unit configured to detect a reaction of the person when the first notification is provided; and a control unit configured to determine whether or not a notification from the notification unit is continued on the basis of the detected reaction, and select a second notification different from the first notification on the basis of the detected reaction and cause the notification unit to provide the second notification in a case where it is determined that the notification is continued.

(2) In the above aspect (1), in a case where it is determined that the notification is continued, the control unit may select the second notification with a notification level different from a notification level of the first notification on the basis of the detected reaction, and cause the notification unit to provide the second notification.

(3) In the above aspect (1) or (2), the notification may be provided by using at least one of an interaction that acts on human vision, an interaction that acts on human hearing, an interaction that acts on the human tactile sense, and an interaction that acts on the human sense of smell.

(4) In the above aspect (3), the interaction that acts on human vision may be performed by using an action of the own apparatus.

(5) In any one of the above aspects (1) to (4), the reaction detection unit may detect a reaction of the person when the second notification is provided, and the control unit may compare a reaction of the person when the first notification is provided with a reaction of the person when the second notification is provided, select an interaction in which the reaction is favorable, and provide a third notification.

(6) In any one of the above aspects (1) to (5), when a plurality of persons are detected in the advancing direction, the reaction detection unit may detect respective reactions of the plurality of detected persons, and the control unit may select the second notification on the basis of the detected reactions of the plurality of persons in a case where the detected reactions of the plurality of persons are the same as each other, and

select the second notification on the basis of a strongest reaction among the detected reactions of the plurality of persons in a case where the detected reactions of the plurality of persons are different from each other.

(7) According to another aspect of the present invention, there is provided an autonomous work setting method including causing a detection unit to detect a person present in an advancing direction of an own apparatus; causing a notification unit to provide a first notification to the detected person; causing a reaction detection unit to detect a reaction of the person when the first notification is provided; and causing a control unit to determine whether or not a notification from the notification unit is continued on the basis of the detected reaction, and select a second notification different from the first notification on the basis of the detected reaction and cause the notification unit to provide the second notification in a case where it is determined that the notification is continued.

(8) According to still another aspect of the present invention, there is provided a program causing a computer to execute detecting a person present in an advancing direction of an own apparatus; providing a first notification to the detected person; detecting a reaction of the person when the first notification is provided; determining whether or not a notification is continued on the basis of the detected reaction; and selecting a second notification different from the first notification on the basis of the detected reaction and providing the second notification in a case where it is determined that the notification is continued.

According to the above aspects (1) to (8), even in a case where a status or an attribute of a target person cannot be recognized, different notifications are provided on the basis of a reaction of the target person, and thus it is possible to perform communication with the target person.

According to the above aspect (2), since a notification level is changed on the basis of a reaction, the second notification can be provided to a target person not showing a reaction to the first notification.

According to the above aspect (3), a notification is provided by using different types of interactions, and thus it is possible to perform communication with a target person.

According to the above aspect (4), a target person is notified by using an action of the own apparatus, and thus it is possible to perform communication with a target person.

According to the above aspect (5), since a plurality of notifications are provided, reactions to the notifications are compared with each other, and the third notification is provided on the basis of an interaction in which a reaction is favorable, it is possible to further perform communication with a target person.

According to the above aspect (6), even in a case where a plurality of target persons are present in the advancing direction, different notifications are provided on the basis of reactions of the plurality of target persons, and thus it is possible to perform communication with the target persons.

### BRIEF DESCRIPTION OF THE DRAWINGS

FIG. 1 is a block diagram illustrating a configuration example of an autonomous work machine according to an embodiment.

FIG. 2 is a side view of the autonomous work machine according to the embodiment.

FIG. 3 is a diagram illustrating an example of stored information that is stored in a storage unit according to the embodiment.

FIG. 4 is a diagram illustrating an example of a work region.

FIG. 5 is a diagram illustrating a first action example of asking movement according to the embodiment.

FIG. 6 is a diagram illustrating a second action example of asking movement according to the embodiment.

FIG. 7 is a diagram illustrating a third action example of asking movement according to the embodiment.

FIG. 8 is a flowchart illustrating process procedures in the autonomous work machine according to the embodiment.

FIG. 9 is a diagram illustrating a first N-notifications means example according to the embodiment.

FIG. 10 is a diagram illustrating a second N-notifications means example according to the embodiment.

FIG. 11 is a diagram illustrating an example of a network according to the embodiment.

FIG. 12 is a flowchart illustrating process procedures in the autonomous work machine using a learned model according to the embodiment.

FIG. 13 is a diagram for describing a reaction detection method in a case where a plurality of persons are present in an advancing direction according to the embodiment.

FIG. 14 is a flowchart illustrating a reaction detection procedure in a case where a plurality of persons are present in an advancing direction according to the embodiment.

### DETAILED DESCRIPTION OF THE INVENTION

Hereinafter, an embodiment of the present invention will be described with reference to the drawings. In the drawings used for the following description, a scale of each member is changed as appropriate such that each member has a recognizable size.

<Configuration of Autonomous Work Machine>

A configuration example of an autonomous work machine 2 will be described.

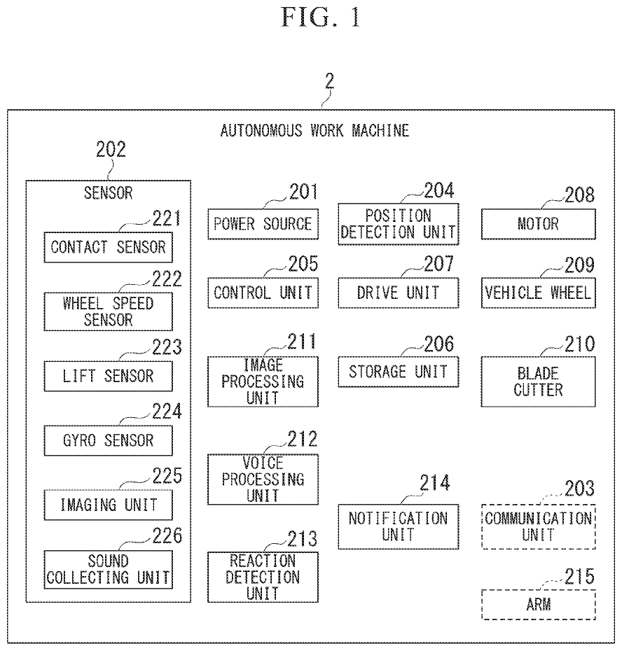

FIG. 1 is a block diagram illustrating a configuration example of the autonomous work machine 2 according to the present embodiment. As illustrated in

FIG. 1, the autonomous work machine 2 includes a power source 201, a sensor 202, a position detection unit 204, a control unit 205, a storage unit 206, a drive unit 207, a motor 208, vehicle wheels 209, a blade cutter 210, an image processing unit 211 (reaction detection unit), a voice processing unit 212 (reaction detection unit), a reaction detection unit 213, and a notification unit 214. The autonomous work machine 2 may further include a communication unit 203 that transmits and receives information via a network and an arm 215 that attempts to contact a target person under the control of the control unit 205.

The sensor 202 includes a contact sensor 221, a wheel speed sensor 222, a lift sensor 223, a gyro sensor 224, an imaging unit 225, and a sound collecting unit 226.

<Functions of Autonomous Work Machine 2>

Next, functions of the autonomous work machine 2 will be described.

The autonomous work machine 2 is an unmanned traveling lawnmower (so-called robot-type lawnmower) that can independently travel to mow grass. As described above, in an apparatus that performs predetermined work, it is difficult to simultaneously provide notifications using, for example, a voice, an image, and an action for reasons such as cost and power consumption.

The power source 201 is, for example, a chargeable secondary battery. The power source 201 may be replaceable, for example, in a pack method. The power source 201 supplies power to each functional unit.

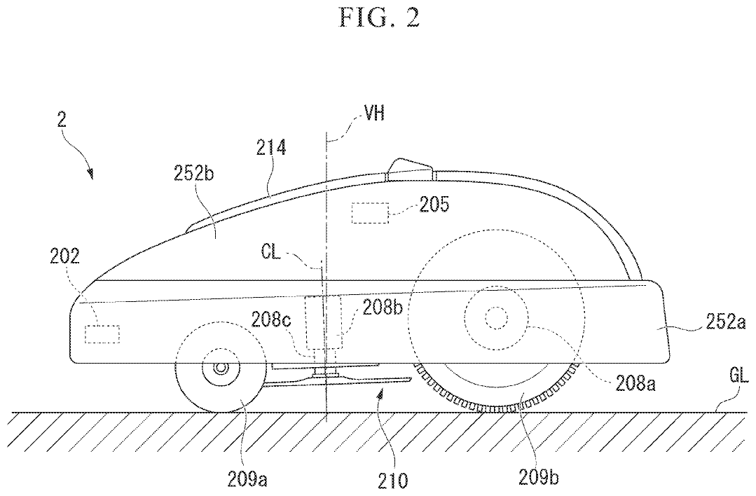

The contact sensor 221 is, for example, an infrared sensor, a reflective sensor, or a time of flight (ToF) sensor. The contact sensor 221 outputs an ON signal to the control unit 205 when a frame 252b (refer to FIG. 2) of the autonomous work machine 2 deviates from a chassis 252a (refer to FIG. 2) due to contact with an obstacle or a foreign substance.

The wheel speed sensor 222 detects information indicating wheel speeds of the vehicle wheels 209.

The lift sensor 223 outputs an ON signal to the control unit 205 when the frame 252b is lifted (raised) from the chassis 252a by a human or the like.

The gyro sensor 224 includes a yaw sensor (angular velocity sensor) that detects a value indicating an angular velocity (yaw rate) generated about a z axis of a centroid position of the autonomous work machine 2, and a G sensor (acceleration sensor) that detects values indicating the accelerations G in X, Y, and Z (three-axis) directions, acting on the autonomous work machine 2.

The imaging unit 225 is, for example, a charge coupled device (CCD) imaging device, or a complementary metal oxide semiconductor (CMOS) imaging device. The imaging unit 225 performs imaging, for example, in an advancing direction of the autonomous work machine 2. An angle of view θ of the imaging unit 225 will be described later. The imaging unit 225 outputs a captured image to the image processing unit 211.

The sound collecting unit 226 is a microphone. Alternatively, the sound collecting unit 226 may be a microphone array including a plurality of microphones. In a case where the sound collecting unit 226 is the microphone array, the plurality of microphones are attached to, for example, the chassis 252a (refer to FIG. 2) of the autonomous work machine 2 (also referred to as an own apparatus) at an equal interval.

In a case where there is a single microphone, the microphone is attached to, for example, the chassis 252a of the own apparatus in the advancing direction thereof. The sound collecting unit 226 collects voice signals, and outputs the collected voice signals to the voice processing unit 212.

The position detection unit 204 is, for example, a Global Positioning System (GPS) receiver, and detects a position of the own apparatus on the basis of information received from satellites. Alternatively, the position detection unit 204 detects a position of the own apparatus, for example, by performing communication with a base station provided around a work region. The position detection unit 204 may acquire time information on the basis of the information received from the satellites or the base station.

The control unit 205 acquires map information stored in the storage unit 206, generates a work instruction on the basis of the acquired map information, and outputs the generated work instruction to the drive unit 207. The control unit 205 acquires a determination result output from the image processing unit 211. In a case where information indicating that a person is present in front of the own apparatus is included in the determination result, the control unit 205 generates notification information on the basis of reaction information output from the reaction detection unit 213, and outputs the generated notification information to the notification unit 214. Alternatively, the control unit 205 acquires a voice recognition processing result output from the voice processing unit 212. In a case where information indicating that a voice is recognizable is included in the voice recognition processing result, the control unit 205 generates notification information on the basis of reaction information output from the reaction detection unit 213, and outputs the generated notification information to the notification unit 214. The notification information is at least one of a voice signal, image information, text information, and beep sound generation instruction information. The control unit 205 may perform communication with a target person by driving the arm 215 on the basis of the notification information. In a case where some or all information stored in the storage unit 206 is preserved on a cloud, the control unit 205 may acquire the information on the cloud via the communication unit 203.

The storage unit 206 stores the map information (information regarding each position in a work region including the map information) of the work region. The storage unit 206 stores the notification information of which a notification is provided. The storage unit 206 stores a template used for comparison during pattern matching for detecting a person (target person). The storage unit 206 stores a database regarding faces used for detection when a reaction of a person is detected on the basis of a facial expression. The storage unit 206 stores a database regarding voices used for detection when a reaction of a person is detected on the basis of emotions contained in a voice. The template, the database regarding faces, and the database regarding voices may be preserved on the cloud.

The drive unit 207 drives the motor 208 in response to the work instruction output from the control unit 205.

The motor 208 includes a vehicle wheel driving motor 208a (refer to FIG. 2) and a blade cutter driving motor 208b (refer to FIG. 2). The vehicle wheel driving motor 208a drives the vehicle wheels 209. The blade cutter driving motor 208b drives the blade cutter 210.

The vehicle wheels 209 include a front wheel 209a (refer to FIG. 2) and a rear wheel 209b (refer to FIG. 2).

The blade cutter 210 is a cutter that mows a lawn.

The image processing unit 211 performs image processing (for example, binarization, edge detection, or feature data detection) on an image output from the imaging unit 225 by using a well-known method, and determines whether or not a person is included in the captured image by using, for example, a pattern matching method. In a case where a person image is included in the captured image, the image processing unit 211 determines whether or not a face image is included therein. In a case where a face image is included, the image processing unit 211 extracts the face image, and outputs the extracted face image to the reaction detection unit 213. The image processing unit 211 outputs a determination result including information indicating whether or not a person is included in, that is, a person is present in front of the own apparatus, to the control unit 205.

The voice processing unit 212 performs a voice recognition process (for example, a speech section detection process or a sound source detection process) on a voice signal output from the sound collecting unit 226 according to a well-known method. In a case where the sound collecting unit 226 is a microphone array, the voice processing unit 212 may perform a sound source positioning process. The voice processing unit 212 outputs a voice recognition process result including information indicating whether or not a voice is recognizable to the control unit 205 and the reaction detection unit 213.

The reaction detection unit 213 determines a reaction of a target person by applying, for example, a facial action coding system (FCCS) theory to the face image output from the image processing unit 211. Specifically, the reaction detection unit 213 assigns a code called an action unit to each muscle, and determines a reaction by determining a facial expression on the basis of a strength or a balance of movement of each code. The reaction detection unit 213 outputs reaction information indicating the detected reaction to the control unit 205.

Alternatively, the reaction detection unit 213 determines a reaction of the target person on the basis of the voice recognition process result output from the voice processing unit 212 by using a speech emotion analysis technique that is a well-known method. The reaction detection unit 213 outputs reaction information indicating the detected reaction to the control unit 205.

The notification unit 214 is, for example, a speaker. The notification unit 214 provides a notification of a voice signal on the basis of the notification information output from the control unit 205.

Alternatively, the notification unit 214 is an image display unit or a lamp. The notification unit 214 generates an image on the basis of the notification information output from the control unit 205, and provides a notification of the generated image. The image of which the notification is provided includes at least one of, for example, text information for asking movement out of a region on which work is to be performed, sign language information, and text information in a language (for example, English) different from a language (for example, Japanese) used for a voice signal. The image may be a still image, and may be a moving image. Alternatively, the notification unit 214 provides a notification by lighting the lamp or provides a notification by flashing the lamp on the basis of the notification information output from the control unit 205. Alternatively, for example, in a case where it is dangerous for a person to be in a target work region, the notification unit 214 may evacuate the person from the target work region by emitting an unpleasant smell to the person on the basis of the notification information output from the control unit 205. Alternatively, the notification unit 214 may guide a person in the target work region by emitting a pleasant smell to the person on the basis of the notification information output from the control unit 205. As described above, in the present embodiment, an interaction that acts on the human sense of smell may be used.

For example, in a case where the autonomous work machine 2 includes a display device having a touch panel sensor, the notification unit 214 may provide a notification by changing a starting orientation such that a person present in a region in the advancing direction described later can view the display device under the control of the control unit 205.

As mentioned above, a notification means includes different types of interactions and is at least one of an interaction that acts on human vision, an interaction that acts on human hearing, an interaction that acts on the human tactile sense, and an interaction that acts on the human sense of smell.

<Example of Appearance of Autonomous Work Machine 2>

Next, an appearance example of the autonomous work machine 2 will be described. FIG. 2 is a side view of the autonomous work machine 2 according to the present embodiment.

As illustrated in FIG. 2, the autonomous work machine 2 includes the frame 252b, the chassis 252a, the right and left front wheels 209a provided at a front part of the chassis 252a, the right and left rear wheels 209b provided at a rear part of the chassis 252a, the sensor 202, the control unit 205, the vehicle wheel driving motor 208a, the blade cutter driving motor 208b, and the blade cutter 210.

The vehicle wheel driving motor 208a is attached to, for example, each of the right and left rear wheels 209b. When the wheel drive motors 208a are rotated normally at a constant speed or in reverse at a constant speed, the autonomous work machine 2 travels straight in the front-rear direction. The autonomous work machine 2 is turned by reversely rotating only one of the right and left wheel driving motors 208a.

The blade cutter 210 is attached to the blade cutter driving motor 208b to be capable of rotating about a rotation shaft 208c that extends in an upward-downward direction with respect to the chassis 252a. The blade cutter 210 has, for example, three blades. The blade cutter 210 is, for example, a press-molded product made of a metal plate material formed in a disk shape with the center CL of the rotation shaft 208c as the rotation center.

The rotation shaft 208c extends in the upward-downward direction of the chassis 252a. The rotation shaft 208c is substantially perpendicular to a horizontal turf GL, that is, a ground GL. Preferably, the rotation shaft 208c is slightly tilted rearward and downward from the top with respect to a vertical line VH. The reason for this is to prevent the blade cutter 210 from rubbing against a lawn surface that has been cut by the blade cutter 210 while the autonomous work machine 2 is traveling forward.

The blade cutter 210 is configured to be able to change a height thereof in the upward-downward direction of the chassis 252a under the control of the control unit 205.

<Stored Information>

Next, an example of stored information that is stored in the storage unit 206 will be described.

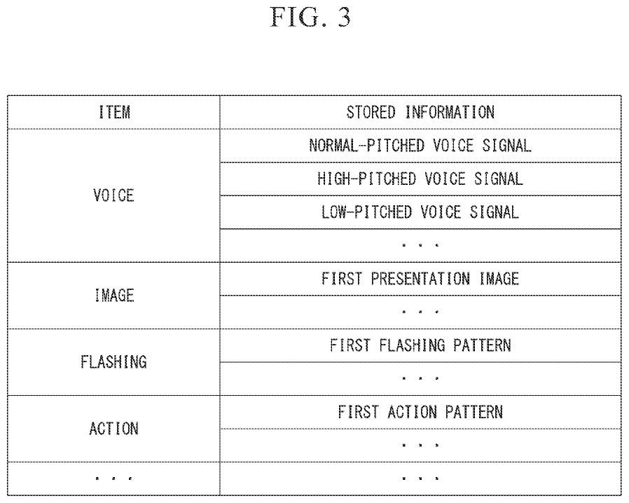

FIG. 3 is a diagram illustrating an example of stored information that is stored in the storage unit 206 according to the present embodiment. As illustrated in FIG. 3, the storage unit 206 stores the stored information in association with, for example, an item. The item includes, for example, a voice, an image, flashing, and an action. Stored information associated with the voice item is, for example, a normal-pitched voice signal, a high-pitched voice signal, and a low-pitched voice signal. Stored information associated with the image item is, for example, a first presentation image. Stored information associated with the flashing item is, for example, a first flashing pattern. Stored information associated with the action item is, for example, a first action pattern.

The examples illustrated in FIG. 3 are only examples, and the present invention is not limited thereto. The storage unit 206 may store information associated with other items, and the number of stored items may be at least two.

<Work Region>

Next, an example of a work region will be described.

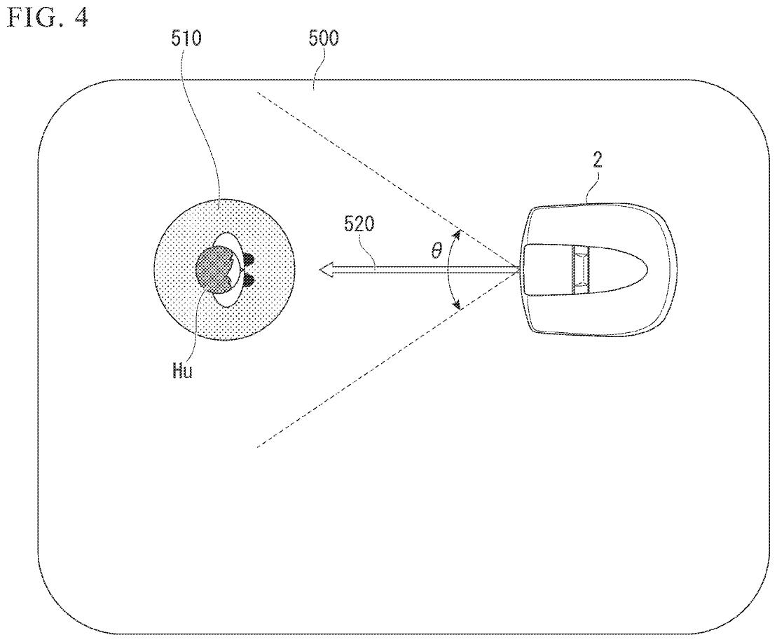

FIG. 4 is a diagram illustrating an example of a work region 500. The work region 500 is, for example, a park. The autonomous work machine 2 mows a lawn in the work region 500. A work route is stored in advance in the storage unit 206 as a shortest route, for example. The example illustrated in FIG. 4 is an example in which a person Hu is present in an advancing direction 520 of the autonomous work machine 2 in the work region 500. The angle of view θ of the imaging unit 225 is at least an angle of view at which a person present in the advancing direction of the own apparatus and rightward movement or rightward and leftward movement of the person can be recognized from an image.

As in the case illustrated in FIG. 4, the autonomous work machine 2 cannot perform lawn mowing work in a region 510 in which the person Hu is present.

Thus, in the present embodiment, in a case where the autonomous work machine 2 cannot perform the work since there is a person in the work region 500, the autonomous work machine 2 asks the target person to move out of the region 510 without making the target person uncomfortable.

<Action Example of Asking Movement>

Here, a description will be made of an action example in which the autonomous work machine 2 asks movement out of the region 510 in which work is performed.

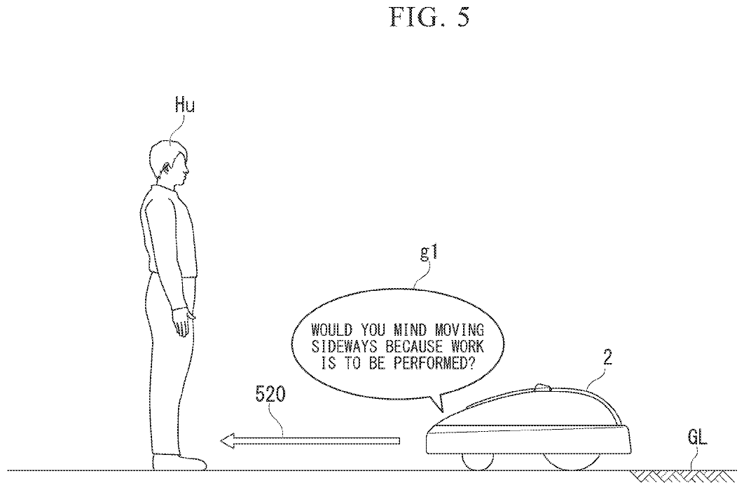

FIG. 5 is a diagram illustrating a first action example of asking movement according to the embodiment. The autonomous work machine 2 detects that the person

Hu is present in the advancing direction 520 on the basis of, for example, a captured image. First, the autonomous work machine 2 presents a voice for asking movement, for example, “Would you mind moving sideways because work is to be performed?”. The autonomous work machine 2 images the person Hu when presenting the voice, and collects the speech of the person Hu. The autonomous work machine 2 determines that a task is completed in a case where the person Hu has moved. The autonomous work machine 2 determines that the task is incomplete in a case where the person Hu does not move.

In a case where the person Hu does not move, the autonomous work machine 2 determines a reaction of the person Hu on the basis of at least one of a captured image and a collected voice signal, and changes a presentation method on the basis of a determination result.

Here, a reaction example of a person will be described.

In a case where a voice signal is presented from a robot such as the autonomous work machine 2, the following reactions may be considered. In a case where the person

Hu is a visually impaired person, there is a probability that the person Hu will move sideways in response to a voice signal even if the autonomous work machine 2 cannot be seen. In a case where the person Hu is a hearing impaired person and is standing with his back to the autonomous work machine 2, or in a case where the person Hu is hearing impaired person and is also a visually impaired person, there is a probability of no reaction that the autonomous work machine 2 cannot be seen and the voice signal cannot be heard. In a case where the person Hu is a healthy person and is standing with his back to the autonomous work machine 2, there is a probability that the person Hu does not see the autonomous work machine 2, but may move because the person Hu can hear the voice signal. Even if the person Hu is a healthy person, there is a probability that the person Hu may ignore the voice signal or show an unpleasant reaction (a face, a behavior, or a speech).

Thus, the autonomous work machine 2 determines a reaction of the person Hu on the basis of at least one of an image captured and a voice signal collected when the voice signal is presented.

In a case of no reaction, the person Hu may have a low-pitched hearing loss or a high-pitched hearing loss. Therefore, the autonomous work machine 2 presents the voice signal to the person Hu by changing the voice signal to, for example, a high-pitched or low-pitched voice signal.

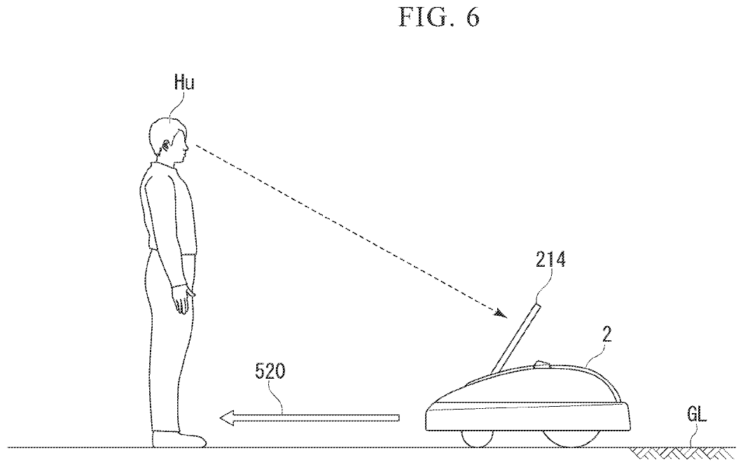

In the case of no reaction, the person Hu may be a hearing impaired person. Therefore, as illustrated in FIG. 6, the autonomous work machine 2 may present, for example, an image to ask movement. FIG. 6 is a diagram illustrating a second action example of asking movement according to the present embodiment. In this case, the autonomous work machine 2 may drive the notification unit 214 including a display device to stand up toward a person such that the display device displays an image for asking movement. The displayed image may include any one of, for example, text in a first language (for example, Japanese), text in a second language (for example, English) different from the first language, a figure moving to the left, and an image of sign language that asks movement.

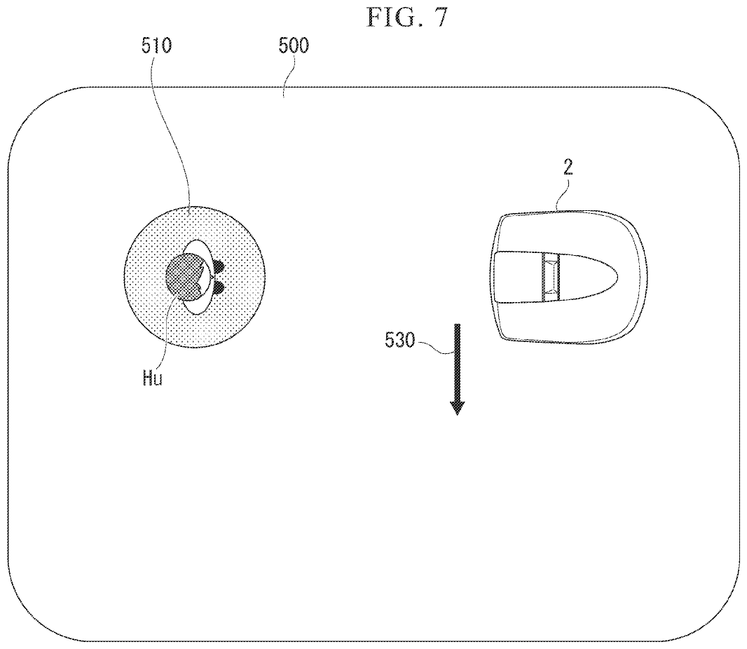

Alternatively, in the case of no reaction, the person Hu may be a hearing impaired person, and thus the autonomous work machine 2 may perform and present a behavior indicating that the person Hu moves sideways as illustrated in FIG. 7. FIG. 7 is a diagram illustrating a third action example of asking movement according to the present embodiment. In this case, the autonomous work machine 2 is controlled to be turned to the left at least once.

In the case of no reaction, the person Hu may be a hearing impaired person, and thus the autonomous work machine 2 may drive the arm 215 to communicate with a target person.

When the autonomous work machine 2 selects the above-described behavior, the autonomous work machine 2 selects a behavior in which the person Hu shows a more friendly reaction on the basis of a determination result.

In a case where the person Hu does not move even if the person Hu is asked to move a plurality of times by using a voice signal, an image, or the like, the autonomous work machine 2 may avoid (leave) the region 510 in which the person Hu is present and perform work.

<Process Procedure Example in Autonomous Work Machine 2>

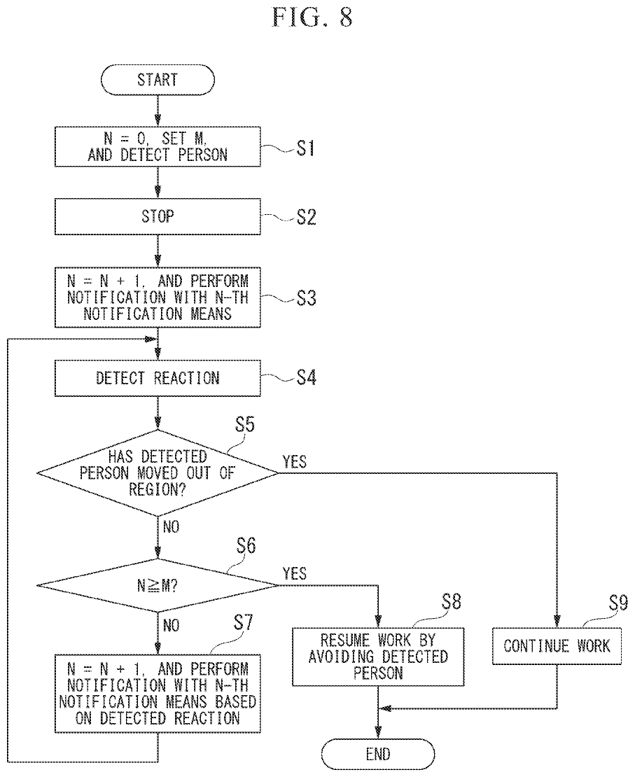

Next, a description will be made of a process procedure example in the autonomous work machine 2. FIG. 8 is a flowchart illustrating process procedures in the autonomous work machine 2 according to the present embodiment. The following process example is an example in which a person is present in a work region in the advancing direction of the own apparatus.

(Step S1) The control unit 205 initializes N to 0, and sets an initial value to M (where M is an integer of 2 or greater). Next, the control unit 205 detects that a person is present in the advancing direction of the own apparatus on the basis of, for example, an image captured by the imaging unit 225.

(Step S2) The control unit 205 controls the own apparatus to stop work and traveling.

(Step S3) The control unit 205 adds 1 to N. Next, the control unit 205 provides a notification with N-th notification means. For example, the control unit 205 provides a notification with first notification means in a case of a first notification, and provides a notification with second notification means in a case of a second notification.

(Step S4) The reaction detection unit 213 detects a reaction of the person on the basis of a captured image or a collected voice signal. The detected reaction includes a reaction regarding whether or not the person has moved. The reaction detection unit 213 detects whether or not the person has moved on the basis of a result of the image processing unit 211 processing the captured image.

(Step S5) The control unit 205 determines whether or not the detected person has moved out of the region 510 (FIG. 4) on the basis of the image processing result in the image processing unit 211. The image processing unit 211 tracks movement of the person included in the image by using a well-known method. In a case where it is determined that the detected person has moved out of the region 510 (step S5; YES), the control unit 205 proceeds to a process in step S9. In a case where it is determined that the detected person has not moved out of the region 510 (step S5; NO), the control unit 205 proceeds to a process in step S6.

(Step S6) The control unit 205 compares N with M to determine whether or not N is equal to or greater than M. In a case where it is determined that N is equal to or greater than M (step S6; YES), the control unit 205 proceeds to a process in step S8. In a case where it is determined that N is smaller than M (step S6; NO), the control unit 205 proceeds to a process in step S7.

(Step S7) The control unit 205 adds 1 to N. Next, the control unit 205 selects N-th notification means on the basis of the reaction detected by the reaction detection unit 213. Next, the control unit 205 provides a notification with the selected N-th notification means. After the process, the control unit 205 returns to the process in step S4.

(Step S8) Since the person in the region has not moved even if N notifications of the movement out of the region are performed, the control unit 205 avoids the detected person and resumes the work. After the process, the control unit 205 finishes a series of processes.

(Step S9) Since the person present in the region has moved, the control unit 205 continues the work in the region in which the detected person is present. After the process, the control unit 205 finishes a series of processes.

<N-Notifications Means Examples>

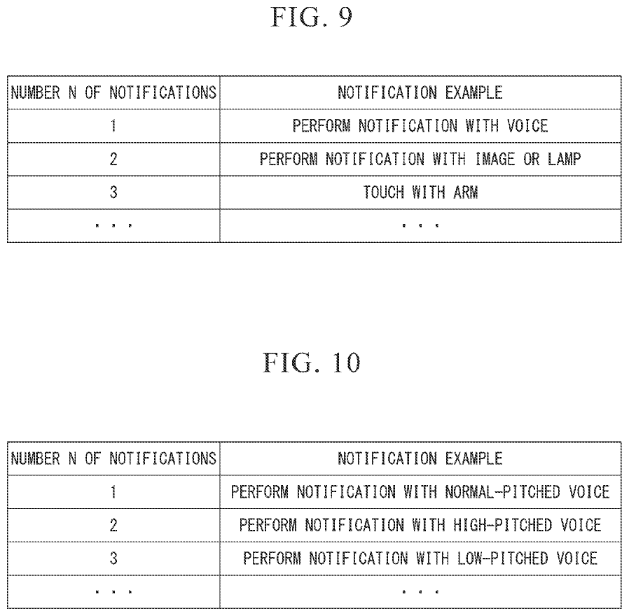

Next, N-notifications means examples will be described with reference to FIGS. 9 and 10.

FIG. 9 is a diagram illustrating a first N-notifications means example according to the present embodiment. In the example illustrated in FIG. 9, in a case of a first notification, the autonomous work machine 2 provides a notification with a voice. In a case of a second notification, the autonomous work machine 2 provides a notification with an image or the lamp. In a case of a third notification, the autonomous work machine 2 is controlled to perform a notification by touching the person with the arm 215.

Consequently, according to the present embodiment, even if a person present in a region in which work is to be performed is, for example, a foreigner who cannot understand a notification language, a hearing impaired person, or a visually impaired person, it is possible to perform a notification with any notification means among a voice, an image, the lamp, and the arm 215. As a result, according to the present embodiment, even in a case where a status or an attribute (a gender, an age, a language used, and the like) of a target person cannot be recognized, it is possible to communicate with the target person.

FIG. 10 is a diagram illustrating an eighth N-notifications means example according to the present embodiment. In the example illustrated in FIG. 10, in a case of a first notification, the autonomous work machine 2 provides a notification with a normal(standard)-pitched voice. In a case of a second notification, the autonomous work machine 2 provides a notification with a high-pitched voice having a range higher than the normal pitch. In a case of a third notification, the autonomous work machine 2 provides a notification with a low-pitched voice having a range lower than the normal pitch.

Consequently, according to the present embodiment, even if a person present in a region in which work is to be performed has a low-pitched hearing loss or a high-pitched hearing loss, it is possible to ask movement out of the region with a voice.

The control unit 205 may gradually increase a volume, such as providing a second notification with a louder voice than in a first notification. Alternatively, in a case where a notification is performed with an image, a size of present text may be gradually increased. In the present embodiment, gradually changing a volume or a size of text as described above will be referred to as changing a notification level.

Consequently, according to the present embodiment, even if a person present in a region in which work is to be performed is a person with a mild hearing loss or a person with a severe hearing loss, it is possible to ask the person to move out of the region with a voice.

The control unit 205 may change a voice tone or a male voice to a female voice, change the female voice to the male voice, and change an adult's voice to a child's voice, such as providing a second notification with a voice with a gentler tone than in a first notification.

Consequently, according to the present embodiment, even if a person present in a region in which work is to be performed does not move because a reaction to a voice in a first notification is an unpleasant reaction, it is possible to ask the person to move out of the region by changing an attribute (a gender, an age, a language used, and the like) of the voice.

In the above example, a description has been made of an example in which a notification is performed with a voice signal as the first notification means, but the present invention is not limited thereto. For example, there is a case where the notification unit 214 does not include a speaker and includes only a display device. In this case, the autonomous work machine 2 provides a first notification by using notification means provided in the autonomous work machine 2. In a case where the notification unit 214 includes only the display device, the autonomous work machine 2 may provide a notification with an image (a still image or a moving image), and changes the image in response to a reaction every notification.

<Machine Learning>

Next, a description will be made of an example of machine learning used in the present embodiment.

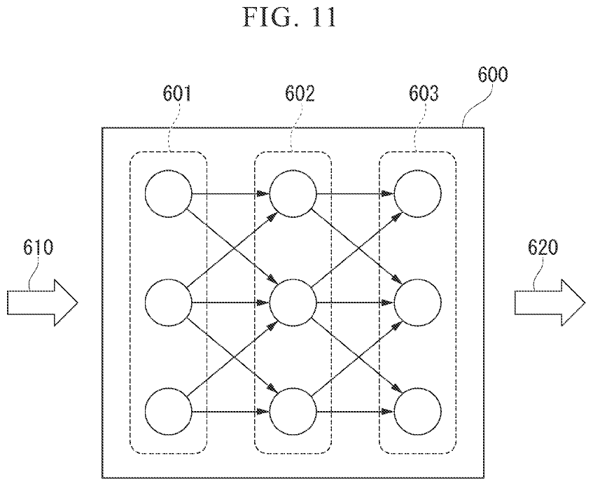

FIG. 11 is a diagram illustrating an example of a network according to the present embodiment.

A network used for learning may be, for example, a deep neural network (DNN), and may be a recurrent neural network (RNN).

As illustrated in FIG. 11, a network 600 includes, for example, an input layer 601, an intermediate layer 602, and an output layer 603. The network 600 may include two or more intermediate layers 602.

In the present embodiment, the autonomous work machine 2 provides a notification to a person present in the advancing direction thereof. As described above, an initial value of the notification is, for example, a voice. In a second notification, notification means is selected in accordance with a reaction of the person to the first notification. The autonomous work machine 2 may learn information obtained in this process and select a notification for a person by also using a learned model.

Input 610 to the network 600 includes at least information of which a notification is provided, a reaction of a person to the notification, training data, and the like. The input 610 may include, for example, a captured image of a face, an address and weather of a work region, and a time period.

The training data for the network is, for example, whether or not a person has moved out of a location where work is to be performed, that is, whether asking movement of the person has succeeded or failed.

Output 620 of the network 600 is notification means with the highest probability of asking a person to move.

The learned model is stored in, for example, the reaction detection unit 213 or the storage unit 206.

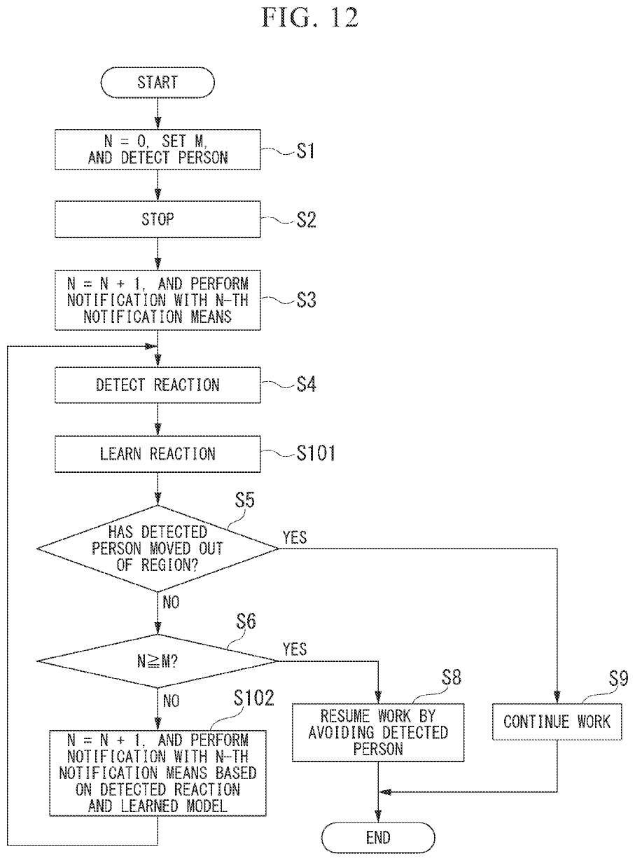

FIG. 12 is a flowchart illustrating process procedures in the autonomous work machine 2 using a learned model according to the present embodiment. The same process as in FIG. 8 will be given the same reference numeral and a description thereof will not be repeated.

(Steps S1 to S4) The control unit 205, the reaction detection unit 213, and the like perform processes in steps S1 to S4. After the processes, the control unit 205 proceeds to a process in step S101.

(Step S101) The control unit 205 learns and updates the notification content of which the notification is provided in step S3 or step S102, the reaction detected in step S4, and the like by using the learning model. After the process, the control unit 205 proceeds to a process in step S5.

(Steps S5 and S6) The control unit 205 performs processes in steps S5 and S6. In a case where it is determined that N is equal to or greater than M (step S6; YES), the control unit 205 proceeds to a process in step S8. In a case where it is determined that N is smaller than M (step S6; NO), the control unit 205 proceeds to a process in step 5102.

(Step S102) The control unit 205 adds 1 to N. Next, the control unit 205 selects N-th notification means on the basis of the reaction detected by the reaction detection unit 213 and the learned model. Next, the control unit 205 provides a notification with the selected N-th notification means. After the process, the control unit 205 returns to the process in step S4.

(Steps S8 and S9) The control unit 205 performs processes in steps S8 and S9. After the process, the control unit 205 finishes a series of processes.

<In Case where Plural Persons are Present in Advancing Direction>

In the above example, as illustrated in FIGS. 4 to 6, a description has been made of an example in which a single person is present in a location where work is performed in the advancing direction, but two or more persons may be present in the advancing direction. For example, a parent and child or a hearing impaired person and a caregiver may be present in the advancing direction.

Hereinafter, a description will be made of an example of a reaction detection method in a case where a plurality of persons are present in the advancing direction.

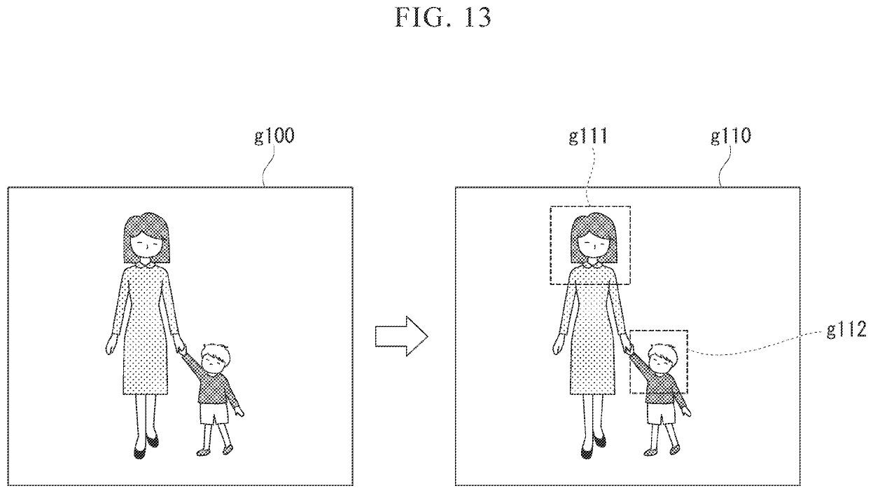

FIG. 13 is a diagram for describing a reaction detection method in a case where a plurality of persons are present in the advancing direction according to the present embodiment. In FIG. 13, g100 illustrates an example in which a parent and a child holding hands in the advancing direction are imaged.

In this case, for example, when both a mother and a daughter are healthy persons, there is a high probability of asking the persons to move in a case where a notification is provided by using a voice as the first notification means. However, for example, when the mother is a hearing impaired person and the daughter is about 2 years old and cannot understand the language yet, there is a possibility that the movement cannot be asked even if a notification is provided with a voice.

In FIG. 13, g110 illustrates examples of face regions detected through image processing. The image processing unit 211 detects face regions gill and g112 by using a well-known face detection method.

As described above, in a case where two or more face regions are detected, the reaction detection unit 213 recognizes a facial expression of each person by using a well-known face recognition method. The reaction detection unit 213 detects reactions on the basis of the detected facial expressions of the plurality of persons. For example, in FIG. 13, after the notification, in a case where the detected facial expressions of the two persons are the same as each other, a reaction is determined on the basis of the detected facial expressions. After the notification, in a case where detected reactions of the two persons are different from reactions when the first notification means is used, a reaction may be determined by giving priority to a stronger reaction. For example, even if a first person shows no reaction, in a case where a second person shows a reaction, the control unit 205 may select the second notification means on the basis of the reaction of the second person.

In the example illustrated in FIG. 13, a description has been made of an example in which the image processing unit 211 detects a plurality of persons present in the advancing direction through image processing, but the present invention is not limited thereto. In a case where the sound collecting unit 226 is a microphone array, the voice processing unit 212 may perform a sound source positioning process, a sound source separation process, or the like on collected sound signals to detect a plurality of persons present in the advancing direction.

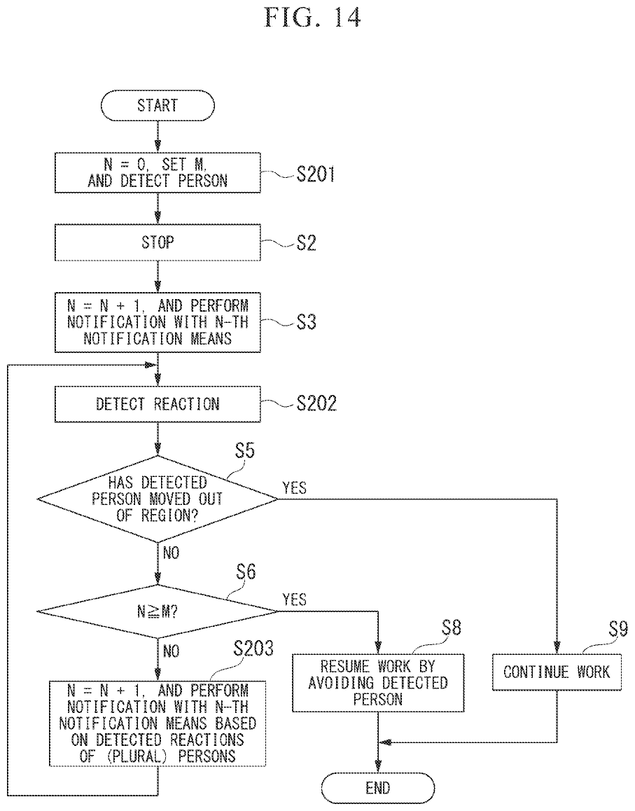

FIG. 14 is a flowchart illustrating a reaction detection procedure in a case where a plurality of persons are present in the advancing direction according to the present embodiment. The same process as in FIG. 8 will be given the same reference numeral and a description thereof will not be repeated.

(Step S201) The control unit 205 initializes N to 0, and sets an initial value to M (where M is an integer of 2 or greater). Next, the control unit 205 detects that a person is present in the advancing direction of the own apparatus on the basis of, for example, an image captured by the imaging unit 225. In this case, the image processing unit 211 detects a face region from the captured image by using a well-known method. After the process, the control unit 205 proceeds to a process in step S2.

(Steps S2 and S3) The control unit 205 performs the processes in steps S2 and S3. After the process, the control unit 205 proceeds to a process in step S202.

(Step S202) The reaction detection unit 213 detects a reaction of the person on the basis of the captured image or the collected voice signal. The detected reaction includes a reaction regarding whether or not the person has moved. The reaction detection unit 213 detects whether or not the person has moved on the basis of a result of the image processing unit 211 processing the captured image. In a case where a plurality of persons are present in the advancing direction, the reaction detection unit 213 detects a reaction of each person. After the process, the reaction detection unit 213 proceeds to a process in step S5.

(Step S5 and S6) The control unit 205 performs the processes in steps S5 and S6. In a case where it is determined that N is equal to or greater than M (step S6; YES), the control unit 205 proceeds to a process in step S8. In a case where it is determined that N is smaller than M (step S6; NO), the control unit 205 proceeds to a process in step S203.

(Step S203) The control unit 205 adds 1 to N. Next, in a case where a single person is detected, the control unit 205 selects N-th notification means on the basis of a reaction of the single person detected by the reaction detection unit 213. Alternatively, in a case where a plurality of persons are detected, the control unit 205 selects the N-th notification means on the basis of reactions of the plurality of persons detected by the reaction detection unit 213. Next, the control unit 205 provides a notification with the selected N-th notification means. After the process, the control unit 205 returns to the process in step S202.

When a third notification is provided, the control unit 205 may compare a reaction of the person when a notification is performed with the first notification means with a reaction of the person when a notification is provided with the second notification means, and select the notification means to which the reaction of the person is favorable, and select the third notification means on the basis of the selected notification means. For example, in a case where a notification is provided with a normal voice signal as the first notification means and there is no reaction, and a notification is provided with a high-pitched voice signal as the second notification means and there is a reaction to the second notification means, the control unit 205 may increase a volume of the voice signal used as the second notification means in the third notification means.

In the process illustrated in FIG. 8 or 14, the image processing unit 211 may estimate the gender or the age of the person included in the image by using a well-known face recognition method or the like. In this case, the control unit 205 may select notification means by also using the estimated gender or age. In a case where it is estimated that the person is a child, the control unit 205 may select a voice signal for children and perform a first notification. The age-specific or gender-specific text or voice signals for notification may be stored in the storage unit 206, and may be stored in the cloud.

As described above, in the present embodiment, when a status or an attribute (an age, nationality, the presence or absence of disability, or the like) of a person cannot be understood, an approach is made by another means in a case where there is no reaction even if specific means is used. As another means, as described above, for example, in a case where there is no reaction even if a notification is provided with a voice, it is determined that a person is a hearing impaired person, and this is coped with by providing a notification with an image. In the above-described way, in the present embodiment, it is possible to realize an interaction that supplements the missing function while using the appropriate function among the limited functions.

Consequently, according to the present embodiment, communication can be performed by changing coping with a person despite the limited functions.

In the above-described embodiment or modification examples, a description has been made of an example in which a person is present in the advancing direction, but the present invention is not limited thereto. The image processing unit 211 may determine a target present in the advancing direction through image processing for comparison with a comparison image stored in the storage unit 206. For example, in a case where there is a pond in a park and turtles live in the park, a turtle coming out of the pond may be on the grass. In this case, the control unit 205 may not perform a notification or perform the notification only once, and may resume work while avoiding the turtle in consideration of a movement speed of the turtle. Alternatively, in a case where a target present in the advancing direction is a bird, a dog, or a cat, the control unit 205 may use a beep sound having a frequency and a volume suitable for the target as notification means.

Consequently, according to the present embodiment, even in a case where a target present in the advancing direction is not a person, movement can be asked and work can be continued.

In the above-described embodiment or modification examples, a description has been made of an example in which a single notification is provided with notification means, but the present invention is not limited thereto. When the autonomous work machine 2 can perform two or more notifications together, the notifications may be simultaneously provided with two types of notification means (for example, a beep sound and flashing of the lamp).

In the above-described embodiment or modification examples, a description has been made of an example in which the advancing direction is a forward direction. For example, in a case where the autonomous work machine 2 has reached a work region, the autonomous work machine 2 may want to move sideways. In this case, the autonomous work machine 2 may perform imaging in a lateral direction thereof, detect a person (a target including the person) present in the lateral direction, and change notification means in accordance with a reaction of the detected person.

In the above-described embodiment or modification examples, a description has been made of an example in which the autonomous work machine 2 is a lawnmower, but the present invention is not limited thereto. The autonomous work machine 2 may be, for example, a self- propelled grass cutter or a self- propelled blower (an apparatus returning cut grass to a site).

The autonomous work machine 2 may be an apparatus that performs work in a predetermined region with a plurality of work machines. For example, the autonomous work machine 2 may be a self-propelled cleaning robot, a self-propelled transport apparatus in a factory, or a self-propelled monitoring apparatus.

A program for realizing all or some of the functions of the autonomous work machine 2 in the present invention may be recorded on a computer-readable recording medium, and the program recorded on the recording medium may be read into a computer system and is executed such that all or some of the processes performed by the autonomous work machine 2 are performed. The “computer system” mentioned here includes an OS or hardware such as peripheral devices. The “computer system” includes a WWW system provided with a homepage provision environment (or display environment). The “computer readable recording medium” refers to, for example, a portable medium such as a flexible disk, a magnetooptical disc, a ROM, or a CD-ROM, or a storage device such as a hard disk built into a computer system. The “computer-readable recording medium” includes a medium that stores the program for a predetermined time, such as a volatile memory (RAM) inside the computer system serving as a server or a client when the program is transmitted via a network such as the Internet or a communication line such as a telephone line.

The program may be transmitted from a computer system that stores the program in a storage device or the like to another computer system via a transmission medium or a transmission wave in the transmission medium. Here, the “transmission medium” for transmitting the program refers to a medium having a function of transmitting information, such as a network (communication network) such as the Internet or a communication line (communication cable) such as a telephone line. The program may be a program for realizing some of the functions described above. The program may be a so-called difference file (difference program), which can realize the above-mentioned function in combination with a program already recorded in the computer system.

Although embodiments for carrying out the present invention have been described by using the embodiments, the present invention is not limited to these embodiments, and various modifications and alternations may occur within the scope without departing from the concept of the present invention.

What is claimed is:

1. An autonomous work machine comprising:
a detection unit configured to detect a person present in an advancing direction of an own apparatus;
a notification unit configured to provide a first notification to the detected person;
a reaction detection unit configured to detect a reaction of the person when the first notification is provided; and
a control unit configured to determine whether or not a notification from the notification unit is continued on the basis of the detected reaction, and select a second notification different from the first notification on the basis of the detected reaction and cause the notification unit to provide the second notification in a case where it is determined that the notification is continued.

2. The autonomous work machine according to claim 1,
wherein, in a case where it is determined that the notification is continued, the control unit selects the second notification with a notification level different from a notification level of the first notification on the basis of the detected reaction, and causes the notification unit to provide the second notification.

3. The autonomous work machine according to claim 1,
wherein the notification is provided by using at least one of an interaction that acts on human vision, an interaction that acts on human hearing, an interaction that acts on the human tactile sense, and an interaction that acts on the human sense of smell.

4. The autonomous work machine according to claim 3,
wherein the interaction that acts on human vision is performed by using an action of the own apparatus.

5. The autonomous work machine according to claim 1,
wherein the reaction detection unit detects a reaction of the person when the second notification is provided, and
wherein the control unit compares a reaction of the person when the first notification is provided with a reaction of the person when the second notification is provided, selects an interaction in which the reaction is favorable, and provides a third notification.

6. The autonomous work machine according to claim 1,
wherein, when a plurality of persons are detected in the advancing direction, the reaction detection unit detects respective reactions of the plurality of detected persons, and
wherein the control unit
selects the second notification on the basis of the detected reactions of the plurality of persons in a case where the detected reactions of the plurality of persons are the same as each other, and
selects the second notification on the basis of a strongest reaction among the detected reactions of the plurality of persons in a case where the detected reactions of the plurality of persons are different from each other.

7. An autonomous work setting method comprising:
causing a detection unit to detect a person present in an advancing direction of an own apparatus;
causing a notification unit to provide a first notification to the detected person;
causing a reaction detection unit to detect a reaction of the person when the first notification is provided; and
causing a control unit to determine whether or not a notification from the notification unit is continued on the basis of the detected reaction, and select a second notification different from the first notification on the basis of the detected reaction and cause the notification unit to provide the second notification in a case where it is determined that the notification is continued.

8. A computer-readable non-transitory storage medium storing a program causing a computer to execute:
detecting a person present in an advancing direction of an own apparatus;
providing a first notification to the detected person;
detecting a reaction of the person when the first notification is provided;
determining whether or not a notification is continued on the basis of the detected reaction; and
selecting a second notification different from the first notification on the basis of the detected reaction and providing the second notification in a case where it is determined that the notification is continued.
